(19) United States
(12) Patent Application Publication
(10) Pub. No.: US 2013/0203495 A1
(43) Pub. Date: Aug. 8, 2013

(54) MULTI-FUNCTIONAL TOUCHPAD REMOTE CONTROLLER

(71) Applicant: ELAN MICROELECTRONICS CORPORATION, HSINCHU (TW)

(72) Inventor: I-HAU YEH, TAIPEI CITY (TW)

(73) Assignee: ELAN MICROELECTRONICS CORPORATION, HSINCHU (TW)

(21) Appl. No.: 13/795,138

(22) Filed: Mar. 12, 2013

Related U.S. Application Data
(63) Continuation of application No. 12/788,696, filed on May 27, 2010.
(60) Provisional application No. 61/183,228, filed on Jun. 2, 2009.

(30) Foreign Application Priority Data
Nov. 9, 2009 (TW) 098137933

(51) Int. Cl. A63F 13/06

(52) U.S. Cl. CPC A63F 13/06
USPC 463/37

(57) ABSTRACT

A multi-functional touchpad remote controller has multiple functional modes to select therefrom and has a touchpad to support touch input. Different patterns may be shown on the touchpad for different functional modes. For the current operation mode, the specific pattern shown on the touchpad allows simple and intuitive to use the multi-functional touchpad remote controller.

### CROSS REFERENCE TO RELATED APPLICATIONS

This application claims the benefit under 35 U.S.C. section 121 of U.S. patent application Ser. No. 12/788,696, filed on May 27, 2010 and under 35 U.S.C. section 119(e) of U.S. Provisional Application No. 61/183,228, filed on Jun. 6, 2009. This application also claims the foreign priority benefit under 35 U.S.C. section 119(a) of Taiwanese Patent Application No. 098137933, filed on Nov. 9, 2009.

### FIELD OF THE INVENTION

The present invention is related generally to a remote controller and, more particularly, to a multi-functional touchpad remote controller.

### BACKGROUND OF THE INVENTION

Remote controllers have been used for a long time in various household appliances such as TV sets, air conditioners, audio/video equipment, electric fans and the like as well as in electrically controllable units such as toys and electrically operated gates. Nowadays, both concepts and products of multimedia computers for use in home theaters become increasingly developed. Such multimedia computers have multimedia components integrated into personal computers and output multimedia information on large-scale displays such as TV sets, projectors or the like, and it has now become possible to have calculation units or integrated circuits with powerful multimedia functions incorporated into large-scale displays. Even further, Microsoft Corporation has developed Media Center Edition (MCE) Operation System, which provides humanity-oriented operation interfaces for multimedia playing so as to allow users, by means of remote controllers, to enjoy a wide variety of digital entertainment programs, e.g., photographs, music, TV programs, movies, home videos, broadcasts, and worldwide programs and services. This tendency towards multimedia integration requires the remote controllers to undertake more tasks. However, nearly all existing technologies focus only on improvement of host terminals but neglect the inconveniences caused by the remote controllers.

Conventional, a typical remote controller is advantageous in that it is intuitive and convenient to operate. Such a remote controller is provided with around twenty buttons, which occupy most of the surface area of the remote controller. If the remote controller is made to have a smaller volume, the buttons would become too small and too dense, making them difficult to operate. On the contrary, if the buttons are made to be relatively larger and sparser, the remote controller would have a bulky volume. For an integrated system, in order to manipulate more kinds of media devices, the remote controller needs to have more buttons, for example, a power switch, audio volume setting buttons, channel selection buttons, numeral buttons, skip buttons, selection buttons of various media functions, operational buttons of single media functions, upward, downward, rightward and leftward movement buttons, a playing button, a reverse button, a fast forward button, a stop button, a recording button and the like. It is much inconvenient for users to choose a desired button among so many buttons without mistakenly depressing other buttons during the operation.

One solution to reduce the number of buttons of a remote controller is to integrate a lot of different functions into some common buttons. For example, selection of a media or function item is accomplished by use of a functional button and direction buttons, so operations through several layers of menus must be performed in order to select an item. Especially, as systematic or media functions become more diversified and complex gradually, operation through several layers of menus is more inconvenient. It is possible that several actions have to be done by users with a dexterous hand in order to accomplish a single control. Even with such integration, the number of buttons of a remote controller may still amount to twenty-five to thirty; moreover, the operation becomes more complex, making it more likely to cause mal-operations. The complex operation usually hinders those unskilled in operating remote controllers to use such a remote controller, for example, the elders, children, those having poor eyesight, those hand-handicapped and those unaccustomed to computer operations.

Use of button operations may also cause limitations on some control functions. For instance, when the remote controller is used to adjust the audio volume, depressing the volume increase or decrease button for the first time will result in appearance of a volume bar, and every subsequent depressing will result in increase or decrease of the audio volume by one unit; and continuous depressing on the button will result in increase or decrease of the audio volume at a fixed changing rate. The same also applies to channel adjustment. When the remote controller is used to adjust luminance, contrast or color of a screen, the user must firstly operate a corresponding button to invoke the specific function and, consequently, an adjustment bar, and then depress the increase or decrease button to increase or decrease the corresponding parameter value by on unit for each depressing operation. If the button is continuously depressed, the parameter value will be increased or decreased at a fixed changing rate. It is impossible to quickly achieve a desired setting in this way of operation. Another way of adjustment is to operate a corresponding button to invoke the specific function and then input a numeric value by depressing numeral buttons so as to have the numeric value come into effect after a while. The latter way of operation is mostly used for channel selection, and still requires the user to look for a specific button on the remote controller.

As currently many electronic products have various multimedia devices integrated therein, it is apparent that functions of the conventional remote controllers have become inadequate for applications in multi-functional systems; for example, it is impossible to execute functions of zooming in, zooming out, dragging and rotating of a frame as well as touch input.

Therefore, it is desired an easy-to-use multi-functional remote controller.

### BRIEF SUMMARY OF THE INVENTION

An object of the present invention is to propose an easy-to-use multi-functional touchpad remote controller.

According to the present invention, a multi-functional touchpad remote controller has a touchpad to detect operation of an object thereon, and multiple light guide films beneath the touchpad for different functional modes respectively.

According to the present invention, a control method for a multi-functional touchpad remote controller having a touchpad comprises enabling an operation mode selected from a plurality of functional modes according to a first control signal, and manipulating a game role with the touchpad responsive to a second control signal if a game controller mode is enabled.

According to the present invention, a control method for a multi-functional touchpad remote controller having a touchpad comprises enabling an operation mode selected from a plurality of functional modes according to a control signal, and detecting a number of objects on the touchpad to determine how to operate if a mouse mode is enabled. In the mouse mode, when the number is one, a pointer on a controlled device is controlled to move or click responsive to movement or clicking of a detected object on the touchpad, and when the number is two, a command is generated depending on an action combination of two detected objects on said touchpad.

According to the present invention, a control method for a multi-functional touchpad remote controller having a touchpad comprises enabling a game controller mode, defining a movement control zone and a functional button control zone on the touchpad, detecting an object movement on said movement control zone to control movement of a game role, and detecting a touched position on said functional button control zone to trigger a functional button which is defined for said touched position.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a block diagram of a system according to the present invention, in which a multi-functional touchpad remote controller is used to control a controlled device;

FIG. 2 is a schematic view illustrating operations when using a multi-functional touchpad remote controller according to the present invention;

FIG. 3 illustrates the keyboard mode of an embodiment control method for a multi-functional touchpad remote controller according to the present invention;

FIG. 4 illustrates the game controller mode of an embodiment control method for a multi-functional touchpad remote controller according to the present invention;

FIG. 5 illustrates the biometrics identifier mode of an embodiment control method for a multi-functional touchpad remote controller according to the present invention;

FIG. 6 illustrates the writing pad mode of an embodiment control method for a multi-functional touchpad remote controller according to the present invention;

FIG. 7 illustrates the remote controller mode of an embodiment control method for a multi-functional touchpad remote controller according to the present invention;

FIG. 8 illustrates the mouse mode of an embodiment control method for a multi-functional touchpad remote controller according to the present invention;

FIG. 9 illustrates the presenter mode of an embodiment control method for a multi-functional touchpad remote controller according to the present invention;

FIG. 10 illustrates a first embodiment of a multi-functional touchpad remote controller according to the present invention, which uses multiple light guide films; and

FIG. 11 illustrates a second embodiment of a multi-functional touchpad remote controller according to the present invention, which uses a multi-layered light guide film.

### DETAILED DESCRIPTION OF THE INVENTION

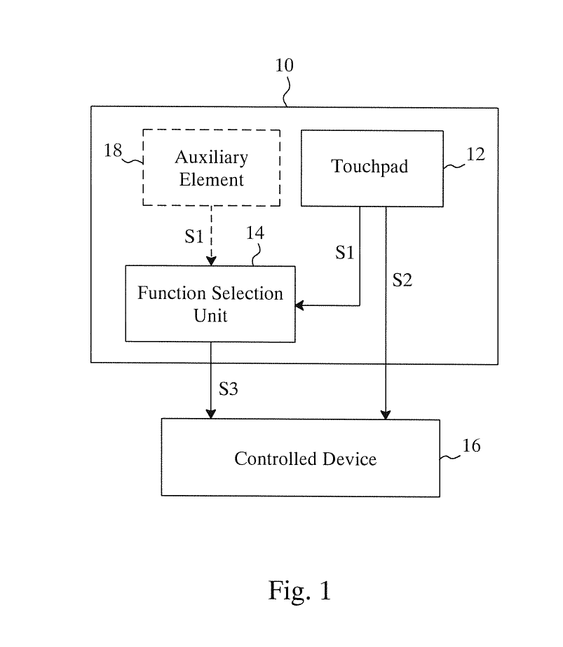

FIG. 1 is a block diagram of a system according to the present invention, in which a multi-functional touchpad remote controller 10 is used to control a controlled device 16. The multi-functional touchpad remote controller 10 includes a touchpad 12 and a function selection unit 14. The touchpad 12 detects the object(s) thereon and the operations of the object(s) to determine control signals S1 and S2 which are sent to the function selection unit 14 and the controlled device 16, respectively, to switch between multiple functional modes and to control the controlled device 16. Responsive to the control signal S1, the function selection unit 14 enables an operation mode selected from the multiple functional modes and directs the controlled device 16 to display a menu or a graphic interface by a control signal S3, so that the user may be informed of the selected functional mode. The control signal S1 may be generated by touching one of a group of functional buttons defined on the touchpad 12, or by performing a gesture on the touchpad 12. Preferably, the gesture may be defined by the user. According to the selected functional mode, the control signal S2 includes commands to instruct the controlled device 16. In other embodiments, as shown in FIG. 1, the multi-functional touchpad remote controller 10 may include an auxiliary element 18, e.g. a button, to generate the control signal S1, so that the user may quickly select an operation mode or switch between the multiple functional modes.

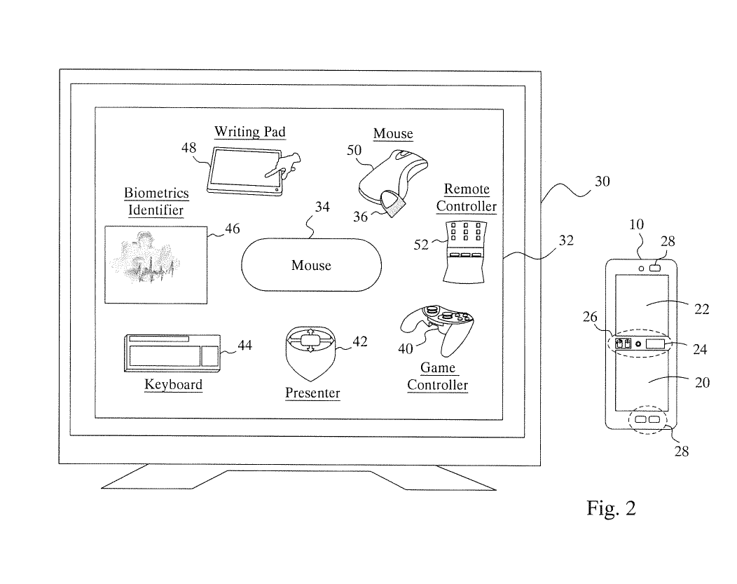

FIG. 2 is a schematic view illustrating operations when using a multi-functional touchpad remote controller 10 according to the present invention. In this case, the multi-functional touchpad remote controller 10 has two touchpads 20, 22, a button assembly 26 including a button 24, a group of biosensors 28 at both sides of the multi-functional touchpad remote controller 10, and a function selection unit (not shown in FIG. 2). When the user presses the button 24, a control signal is generated to signal the function selection unit within the multi-functional touchpad remote controller 10 as shown in FIG. 1, to direct a controlled device to display an operation interface 32 on a display 30, which includes multiple icons, such as a game controller 40, a presenter 42, a keyboard 44, a biometrics identifier 46, a writing pad 48, a mouse 50, a remote controller 52, representative of the options for the multi-functional touchpad remote controller 10 able to operate the controlled device. When the operation interface 32 is displayed, a functional mode dialog 34 appears at the center of the operation interface 32 to indicate the functional mode to be selected. When the user moves his finger on the touchpad 20 or 22, the position of the user's finger is displayed by the operation interface 32 as a pointer 36 on the display 30. As the pointer 36 moves among the selectable icons, the name of the functional mode currently pointed by the pointer 36 will be displayed by the functional mode dialog 34, which makes it convenient for the user to know which functional mode is represented by the pointed icon. Once an icon is clicked, the corresponding functional mode will be activated. In other embodiments, a group of functional buttons may be defined on the touchpad 20 or 22 to replace the button assembly 26; alternatively, instead of pressing the button 24, a gesture may be performed by the user on the touchpad 20 or 22 to display the operation interface 32 on the display 30.

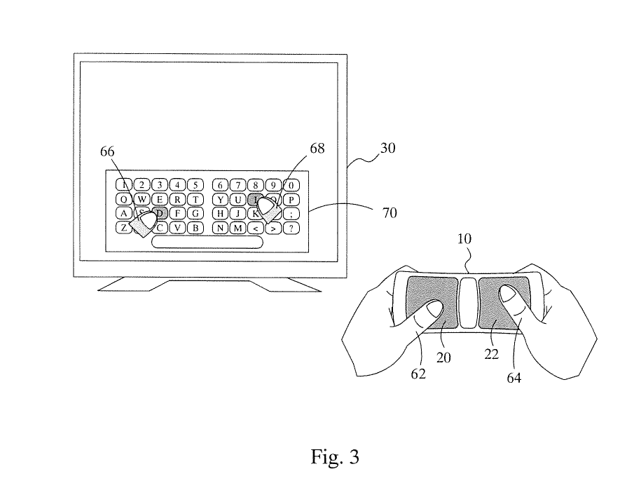

FIGS. 3-9 schematically illustrate the operations of the functional modes in a control method of the system shown in FIG. 2.

FIG. 3 illustrates the keyboard mode. When the keyboard icon 44 shown in FIG. 2 is clicked, the keyboard mode is enabled, and a graphic interface defining a virtual keyboard 70 is displayed on the display 30. As two fingers 62 and 64 move on the touchpads 20 and 22, pointers 66 and 68 representative of the fingers 62 and 64 on the touchpads 20 and 22 will be displayed on the display 30 so that the user can know the positions of the fingers 62 and 64 directly from the pointers 66 and 68 without having to look at the multi-functional touchpad remote controller 10. In this keyboard mode, the touchpads 20 and 22 are defined as sensing blocks corresponding to the virtual keyboard 70, which includes virtual keys defined as the keys of basic symbols, numerals or English letters on the virtual keyboard 70. By operating the touchpads 20 and 22 with the fingers 62 and 64, corresponding key input is accomplished as typing on the virtual keyboard 70.

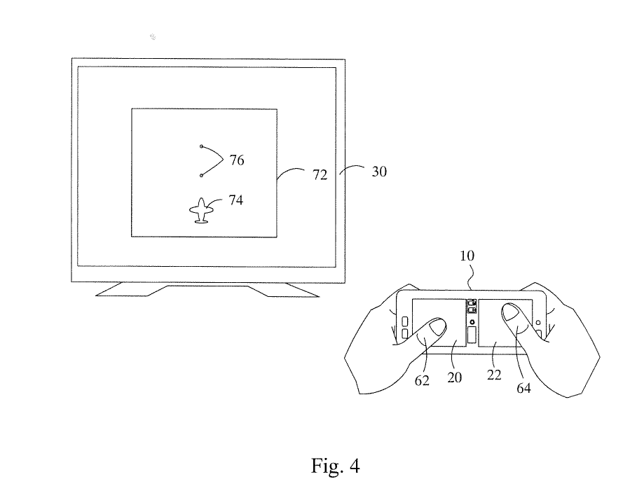

FIG. 4 illustrates the game controller mode. When the game controller icon 40 shown in FIG. 2 is clicked, the game controller mode is enabled, and the multi-functional touchpad remote controller 10 becomes a game pad by rotating it to the horizontal orientation. In this embodiment, the touchpads 20 and 22 are defined as a movement control zone and a functional button control zone, respectively. Functions of the touchpads 20 and 22 may be swapped with each other depending on the user's habits. When playing a game, through movement of the finger 62 on the touchpad 20, movement of a game role 74 on the game interface 72 is controlled correspondingly. Because progress of the game is controlled directly by movement of the finger 62, a more convenient hand feeling is obtained as compared to the typical four-directional, eight-directional or analog game pads. Furthermore, by slightly touching the positions defined as the functional buttons on the touchpad 22 with the finger 64, the game role 74 will be enabled to perform a corresponding action, for example, firing bullets 76.

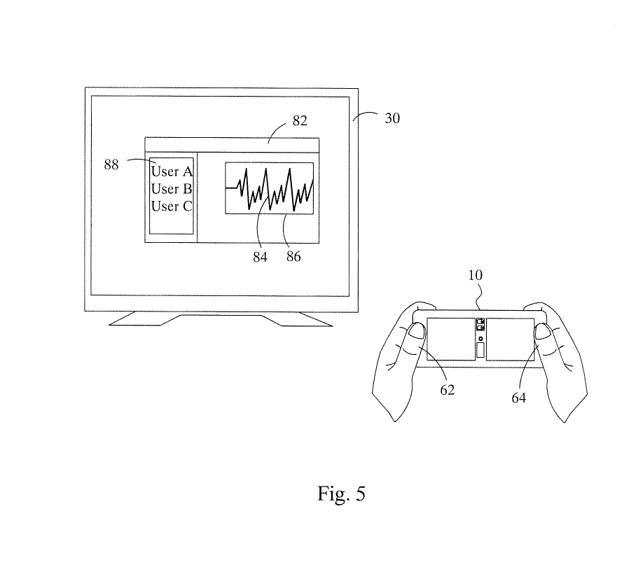

FIG. 5 illustrates the biometrics identifier mode. When the biometrics identifier icon 46 shown in FIG. 2 is clicked, the biometrics identifier mode is enabled, and a biometrics interface 82 is displayed on the display 30. When the user places his fingers 62 and 64 on the biosensors 20 shown in FIG. 2, a loop circuit will be established by the user and the multi-functional touchpad remote controller 10, so that a bio-signal 84, e.g. heart beat information, of the user may be sensed by the biosensors 20 and displayed in a bio-signal displaying window 86. Through the measurement, a database of the user's own bio-signals can be established in a user database 88 of the biometrics interface 82. The user database 88 may be configured to store bio-signals of different users. As each user's bio-signal 84 has its own unique characteristics, identity of the current user of the multi-functional touchpad remote controller 10 may be identified by comparing the data sensed by the biosensors with those of the database. The aforesaid identification function has a lot of advantages and may be used in a lot of situations, for example, to validate a user's identity in a computer game competition or to provide a data confidentiality function for the user so as to greatly improve the security as compared to the conventional password approaches. Alternatively, by establishing in the user database 88 interrelations between identities of individual users and their preference settings, preference settings, e.g., audio volume, picture quality, etc., of a user can be chosen automatically once the user identity is determined. On the other hand, these preference settings may be also used to prevent minors at home from accessing unhealthy media information such as violent programs, games and so on.

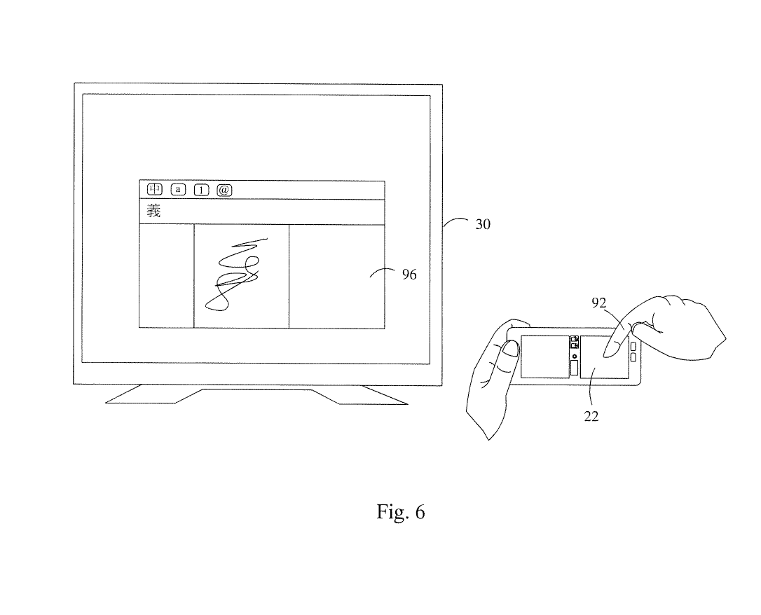

FIG. 6 illustrates the writing pad mode. Once the writing pad icon 48 shown in FIG. 2 is clicked, the writing pad mode is enabled, and a writing input window 96 is popped up for the user to input texts, symbols or freehand graphics. As the user's finger 92 slightly touches and slides on the touchpad 22, the movement trace of the finger 92 appears in the writing input window 96. The movement trace is then identified by text recognition software to accomplish the purpose of inputting texts or symbols. In other embodiments, a drawing recognition program or an image processing program may be also used in combination to input a desired image by hand on the touchpad 22.

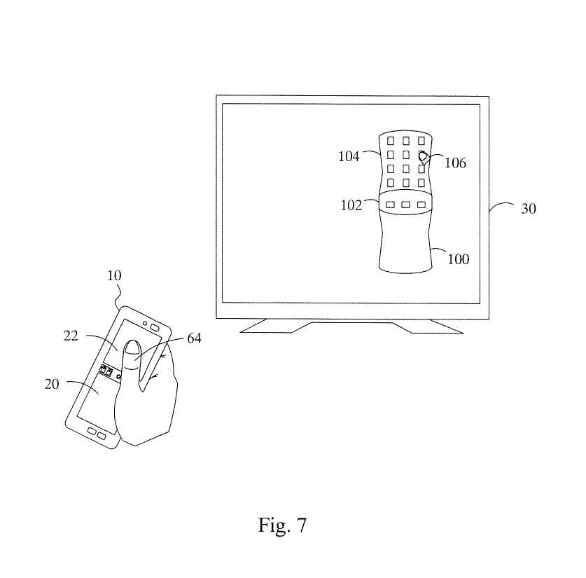

FIG. 7 illustrates the remote controller mode. When the remote controller icon 52 shown in FIG. 2 is clicked, the remote controller mode is enabled, and a graphic interface defining a virtual remote controller 100 is displayed on the display 30. The touchpad 22, corresponding to the portion 104 of the virtual remote controller 100 displayed on the display 30, is defined with input buttons thereon, e.g., numeral buttons, enter button, delete button, etc. The other touchpad 20 may be defined with different functional buttons thereon; for example, the portion 102 of the virtual remote controller 100 shown in FIG. 7 includes functional buttons for upward or downward channel selection, audio volume adjustment, muting and so on. As the finger 64 slightly touches and slides on the touchpads 20 and 22, a pointer 106 displayed on the display 30 moves correspondingly to facilitate selection of individual buttons by the user from the graphic interface 100. In this mode, the multi-functional touchpad remote controller 10 may be further configured into a plurality of functional modes to respond to different controlled devices. For example, in a TV remote controller mode, the multi-functional touchpad remote controller 10 may be used to select a TV channel; in a VCR remote controller mode, the multi-functional touchpad remote controller 10 may be used to control playing, fast forward or selection of a section of a movie to watch; and in a jukebox remote controller mode, the multi-functional touchpad remote controller 10 may be used to select a music piece.

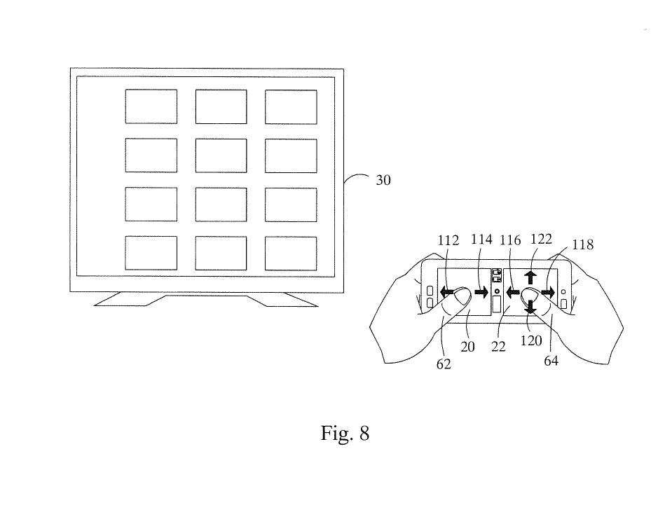

FIG. 8 illustrates the mouse mode. When the mouse icon 50 shown in FIG. 2 is clicked, the mouse mode is enabled. Besides that the functions of a typical mouse, such as moving a cursor, single-click for selection, double-click for execution, may be accomplished, it may also be defined that actions made by two fingers 62 and 64 on the touchpads 20 and 22 trigger different commands, e.g., paging up or down, zooming in or out, and rotation, so as to make it convenient for the user to browse a file. In FIG. 8, if both the fingers 62 and 64 slide towards the leftwards directions 112 and 116 on the touchpads 20 and 22 at the same time, it represents that a “page up” instruction will be issued; or if both the fingers 62 and 64 slide towards the rightwards directions 114 and 118 at the same time, it represents that a “page down” instruction will be issued. If the fingers 62 and 64 slide towards the opposite directions 112 and 118 respectively, it represents that a “zoom in” instruction will be issued; contrarily, if the fingers 20 and 22 slide towards the opposite directions 114 and 116 respectively, it represents that a “zoom out” instruction will be issued. If the finger 62 is placed fixedly on the touchpad 20 while the other finger 64 slides on the touchpad 22 downwards in a direction 120 or upwards in a direction 122 shown in FIG. 8, it represents that a “clockwise rotation” instruction or a “counterclockwise rotation” instruction will be issued.

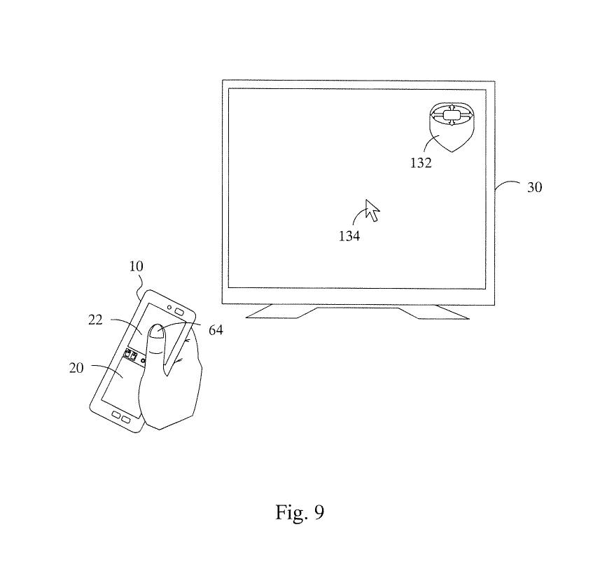

FIG. 9 illustrates the presenter mode. When the presenter icon 42 shown in FIG. 2 is clicked, the presenter mode is enabled, and the touchpad 22 is defined with four directional buttons, namely, an upward button, a downward button, a leftward button, and a rightward button. When the user presses one of these directional buttons, the directional button 132 on the display 30 will display the pressed directional button and a function corresponding to the pressed directional button will be performed, for example, to page up, to page down and so on. In this case, the touchpad 20 has the functions of a typical mouse and a cursor 134 is displayed on the display 30, so that a finger moves on the touchpad 20, the cursor 134 will move correspondingly.

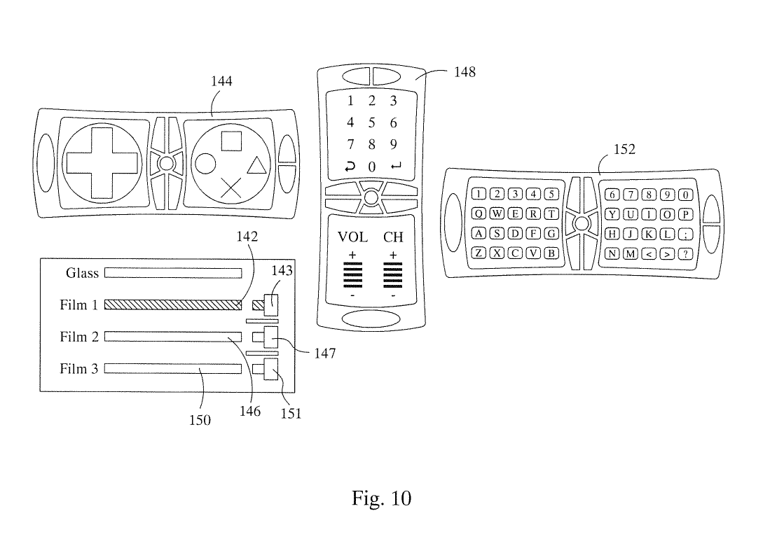

Light guide films may be used in the multi-functional touchpad remote controller 10. For example, as shown in FIG. 10, the touchpads 20 and 22 shown in FIG. 2 include multiple light guide films 142, 146, and 150, each of which is connected with a respective one of side-emitting light-emitting elements 143, 147, and 151. In this structure, the light-emitting elements 143, 147, and 151 are used to provide light for the light guide films 142, 146, and 150 respectively, and the latter will guide the light by refraction principle. Each of the light guide films 142, 146, and 150 has a pattern for one of the multiple functional modes, and with the light provided by the corresponding one of the light-emitting elements 143, 147, and 151, this pattern will be shown on the touchpads 20 and 22. For instance, when the game controller mode is enabled, only the light-emitting element 143 connected to the light guide film 142 functions so as to render only the pattern 144 on the light guide film 142 visible and therefore, as shown by the pattern 144, items such as the movement control zone and the functional button control zone will be shown on the touchpads 20 and 22. When the multi-functional touchpad remote controller 10 is switched to the remote controller mode, only the light-emitting element 147 connected to the light guide film 146 functions so as to render the pattern 148 on the light guide film 146 visible and therefore, as shown by the pattern 148, numeral buttons and functional buttons will be shown on the touchpads 20 and 22. When the multi-functional touchpad remote controller 10 is switched to the keyboard mode, only the light-emitting element 151 connected to the light guide film 150 functions so as to render the pattern 152 on the light guide film 150 visible and therefore, as shown by the pattern 152, basic symbols, numerals and English letters will be shown on the touchpads 20 and 22.

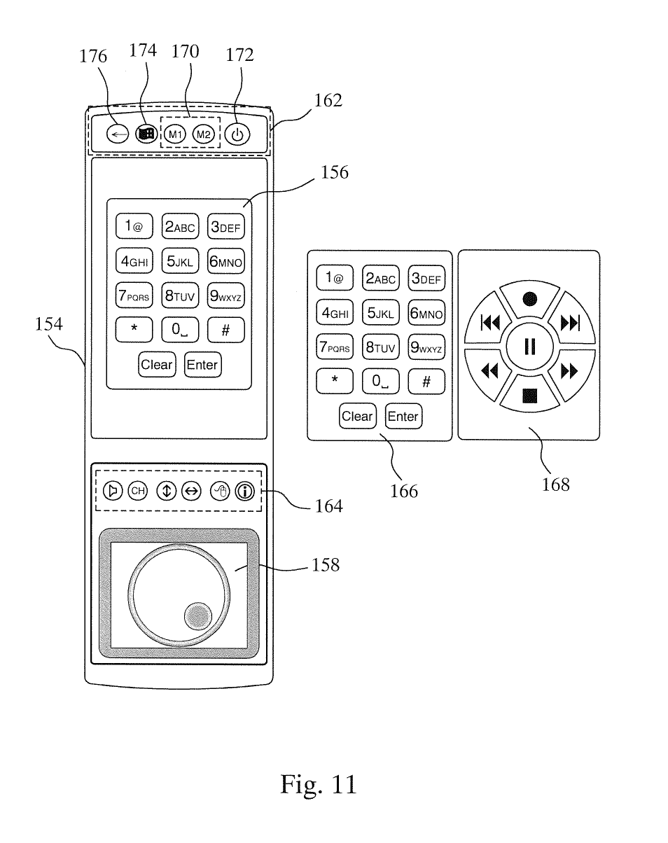

FIG. 11 illustrates another embodiment of the multi-functional touchpad remote controller 154 which includes two touchpads 156 and 158 and functional button assembly 162 and 164 to switch the touchpads 156 and 158 between multiple functional modes. The touchpad 156 includes a multi-layered light guide film to show the pattern 166 or 168 depending on the enabled functional mode. When the user uses the functional button assembly 162 above the touchpad 156 to enable a keypad mode, a defined keypad zone will be displayed on the touchpad 156 through the pattern 166 on the multi-layered light guide film for the user to input numerals into a multimedia computer, to input texts in a Chinese Pinyin input method by means of the virtual keypad built-in the multimedia computer, or to select a channel. When a multimedia mode is enabled by the user, a defined multimedia control zone will be displayed on the touchpad 156 through the pattern 168 on the multi-layered light guide film for the user to execute a multimedia operation, for example, including functions of audio 86 video (AV) playing, pause, stop, video recording, fast forwarding, fast reversing, scrolling up, scrolling down or the like. In addition to a mode button 170 for enabling different functional modes of the touchpad 156, functional buttons for use in conjunction with a multimedia computer are defined in the functional button assembly 162, e.g., a sleep/enable button 172, an operation system functional button 174, a page-up button 176 and the like. The other touchpad 158 is for implementing the functions such as quick searching, quick channel switching, audio volume adjustment, channel switching and directional (e.g. upward, downward, leftward and rightward) movement, etc. For example, clockwise rotation of a finger on the touchpad 158 represents an increase in audio volume, upward channel switching, upward movement or rightward movement; contrarily, counterclockwise rotation of a finger on the touchpad 158 represents a decrease in audio volume, downward channel switching, downward movement or leftward movement. Thus, manipulation can be accomplished by the user simply by selecting a desired functional mode through the functional button assembly 164 located above the touchpad 158.

As can be appreciated from the above description of the present invention, by using a touchpad as an input interface of a remote controller and defining arrangement of the touchpad according to different functional modes, the remote controller can be provided with a plurality of functions. According to the present invention, the user may operate the touchpad of a multi-functional touchpad remote controller by means of an operation interface displayed on a display, which obviously makes the multi-functional touchpad remote controller simple and intuitive to use. By integrating the multiple light guide films shown in FIG. 10 or the multi-layered light guide film shown in FIG. 11 into the touchpad, the multi-functional touchpad remote controller of the present invention is allowed to display different operation interfaces depending on different functional modes. Furthermore, conventional channel selection buttons and functional adjustment buttons may be further disposed on a back side of the multi-functional touchpad remote controller of the present invention so that the multi-functional touchpad remote controller can be turned over for use; alternatively, buttons may be sandwiched into an interlayer, in which case the buttons can be used after the touchpad disposed thereon is flipped open or slid open.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A multi-functional touchpad remote controller, comprising:
a function selection unit operative to enable an operation mode selected from a plurality of functional modes according to a first control signal; and
a touchpad operative to detect operation of at least an object thereon to provide a second control signal;
wherein if a game controller mode is enabled, said touchpad manipulates a game role according to its detected operation of said at least an object.

2. The multi-functional touchpad remote controller of claim 1, wherein if a keyboard mode is enabled, said touchpad activates a plurality of virtual keys defined thereon to simulate a virtual keyboard defined with a graphic interface displayed on a controlled device such that a pointer displayed on said controlled device will move to a key of said graphic interface responsive to a touch on one of said plurality of virtual keys which is defined as said key of said graphic interface.

3. The multi-functional touchpad remote controller of claim 1, wherein said first control signal is generated according to a gesture on said touchpad.

4. The multi-functional touchpad remote controller of claim 1, wherein said touchpad comprises a functional button assembly defined thereon to generate said first control signal responsive to a touch thereto.

5. The multi-functional touchpad remote controller of claim 1, further comprising an auxiliary element connected to said function selection unit, operative to generate said first control signal.

6. The multi-functional touchpad remote controller of claim 5, wherein said auxiliary element comprises a button assembly.

7. The multi-functional touchpad remote controller of claim 1, wherein said function selection unit directs a controlled device to display an operation interface including a plurality of icons defined for said plurality of functional modes respectively.

8. The multi-functional touchpad remote controller of claim 1, further comprising a button assembly configured to manipulate channel selection and functional adjustment setting of a controlled device.

9. The multi-functional touchpad remote controller of claim 1, further comprising at least a layer of light guide film beneath said touchpad for one of said plurality of functional modes.

10. The multi-functional touchpad remote controller of claim 9, wherein said light guide film comprises:
a thin film having a pattern thereon; and
a light-emitting element connected to said thin film, for providing light to said thin film to thereby show said pattern on said touchpad.

11. A control method for a multi-functional touchpad remote controller having a touchpad, said control method comprising the steps of:
(a) enabling an operation mode selected from a plurality of functional modes according to a first control signal;
(b) if a game controller mode is enabled, providing a second control signal by said touchpad according to operation of at least an object on said touchpad; and
(c) manipulating a game role responsive to said second control signal.

12. The control method of claim 11, further comprising the steps of:
if a keyboard mode is enabled, directing said controlled device to display a graphic interface defining a keyboard;
activating a plurality of virtual keys defined on said touchpad to simulate said keyboard; and
moving a pointer displayed on said controlled device to a key of said graphic interface responsive to a touch on one of said plurality of virtual keys which is defined as said key of said graphic interface.

13. The control method of claim 11, further comprising the step of directing said controlled device to display an operation interface including a plurality of icons defined for said plurality of functional modes respectively.

14. The control method of claim 11, further comprising the steps of:
activating a functional button assembly defined on said touchpad; and
generating said first control signal responsive to a touch on said functional button assembly.

15. The control method of claim 11, further comprising the steps of:
detecting a gesture on said touchpad; and
generating said first control signal responsive to said gesture.

16. The control method of claim 11, further comprising the step of generating said first control signal responsive to a depressing of a button assembly on said multi-functional touchpad remote controller.
